(19) United States
(12) Patent Application Publication
(10) Pub. No.: US 2024/0085699 A1
(43) Pub. Date: Mar. 14, 2024

(54) VEHICLE PANE FOR A HEAD-UP DISPLAY

(71) Applicant: SAINT-GOBAIN GLASS FRANCE, COURBEVOIE (FR)

(72) Inventors: Andreas GOMER, KERPEN (DE); Valentin SCHULZ, NIEDERZIER (DE)

(21) Appl. No.: 18/262,835

(22) PCT Filed: Jan. 24, 2022
(86) PCT No.: PCT/EP2022/051431

§ 371 Date: Jul. 25, 2023

(30) Foreign Application Priority Data
Jan. 26, 2021 (EP) 21153380.7

(51) Int. Cl. G02B 27/01; B32B 17/10; B60J 1/02

(52) U.S. Cl. CPC G02B 27/0103; B32B 17/10036; B32B 17/10449; B32B 17/10467; B32B 17/10761; B32B 17/10807; B60J 1/02; B60K 35/00; G02B 2027/011

(57) ABSTRACT

A vehicle pane for a head-up display having, in the installed state, an outer side facing external surroundings and an inner side facing a vehicle interior, includes at least one transparent pane, at least one first masking strip in an edge region of the pane, wherein the at least one first masking strip is arranged on or in a carrier film and, in particular, is printed on the carrier film or embedded in the carrier film, and the carrier film is bonded to the at least one transparent pane, and at least one light-deflecting device for deflecting light into the vehicle interior or at least one image display device for displaying image information, which is arranged in the region of the masking strip, on the vehicle-interior side of the masking strip.

The invention relates to a vehicle pane for a head-up display, a method for production thereof, and use thereof, as well as a head-up display with the vehicle pane and a correspondingly equipped vehicle.

Vehicles, in particular passenger cars, are increasingly equipped with so-called displays and in particular head-up displays (HUDs). Examples for such displays are disclosed in WO 2019/150038 A1, U.S. Pat. No. 10,300,680 B2, US 2009/295681 A1, JP H06 279071 A, or DE 10 2016 211823 A1 Head-up-displays are provided for displaying image information for a viewer or driver. With a projector as an image generator, for example, in the region of the dashboard or in the roof region, images are projected onto the windshield, reflected there, and perceived by the driver as a virtual image behind the windshield. Thus, important information can be projected into the driver's field of vision, for example, the current driving speed, navigation or warning messages, which the driver can perceive without having to take his eyes off the road. Head-up displays can thus contribute significantly to an increase in traffic safety.

Usually, vehicle panes serving as windshields consist of two glass panes that are laminated to one another via a thermoplastic film. With the above described head-up display, the problem arises that the projector image is reflected on both surfaces of the windshield. Thus, the driver perceives not only the desired primary image, which is caused by the reflection on the interior-side surface of the windshield (primary reflection). The driver also perceives a slightly offset secondary image, usually weaker in intensity, which is caused by the reflection on the exterior-side surface of the windshield (secondary reflection). This problem is commonly resolved in that the reflecting surfaces are arranged at an angle relative to one another deliberately selected such that the primary image and the secondary image coincide, as a result of which the secondary image is no longer disturbingly noticeable.

It is also known to provide vehicle panes with transparent, electrically conductive coatings. These coatings can act, for example, as IR-reflecting coatings to reduce the heating of the vehicle interior and thus to improve thermal comfort or can be used as heatable coatings by connecting them to a voltage source such that a current flows through the coating. Vehicle panes with conductive coatings in the interior of the composite glass have, in connection with head-up displays, the problem that the conductive coating forms an additional reflecting boundary surface for the projector image. This also results in an undesirable secondary image.

In principle, the components of the head up display must be arranged in the vehicle such that the viewer can see the projected image, which inevitably entails restrictions in terms of the arrangement in the vehicle, since the reflection of light rays on the reflecting surface of the vehicle pane satisfies the condition that the angle of incidence corresponds to the the angle of reflection.

When designing a head-up display, care must further be taken to ensure that the projector has correspondingly high power such that the projected image has sufficient brightness, in particular in the case of incident sunlight and is readily recognizable by the viewer. This requires a certain size of the projector and is associated with corresponding power consumption.

In contrast, the object of the present invention consists in providing an improved head-up display, with which these disadvantages can be avoided. For example, it would be desirable to have a head-up display in which no unwanted secondary images occur and whose arrangement in the vehicle can be implemented relatively easily with good recognizability with sufficient brightness and contrast of the image information displayed. The energy consumption of a projector should be relatively low. In addition, the head-up display should be easy and economical to produce in the industrial series production of vehicles.

These and other objects are accomplished according to the proposal of the invention by a vehicle pane and a head-up display with such a vehicle pane, as well as a correspondingly equipped vehicle, in accordance with the coordinate claims. Advantageous embodiments of the invention emerge from the dependent claims.

According to the invention, a vehicle pane is shown that serves to separate a vehicle interior from external surroundings of the vehicle. The vehicle pane comprises at least one transparent pane. In principle, the vehicle pane can be implemented in any desired form, in particular as thermally toughened single pane safety glass or as a composite pane. Preferably, the vehicle pane serves as a vehicle windshield.

Preferably, the vehicle pane according to the invention, in particular the vehicle windshield, is implemented as a composite pane and comprises a first pane with an outer face and an inner face as well as a second pane with an inner face and an outer face, that are fixedly joined to one another by at least one thermoplastic intermediate layer (adhesive layer). The first pane can also be referred to as the “outer pane”; the second pane, as the “inner pane”. From the outside to the inside, the surfaces or faces of the two individual panes are commonly referred to as side I, side II, side III, and side IV.

The vehicle pane according to the invention has, in the installed state in the vehicle, an outer face facing the external surroundings and an inner face facing the vehicle interior. In a vehicle pane implemented as a composite pane, the outer face of the first pane is the outer face of the vehicle pane and the inner face of the second pane is the inner face of the vehicle pane.

The vehicle pane according to the invention has at least one first masking strip, in an edge region that is typically adjacent the pane edge of the pane, wherein the at least one first masking strip is arranged on or in a carrier film. The carrier film is bonded, directly or indirectly, for example, via an intermediate layer or multiple intermediate layers, to the at least one transparent pane.

The carrier film is preferably a polymer film, which particularly preferably contains polyethylene terephthalate (PET), polypropylene (PP), polyacrylate, polyethylene (PE), polycarbonate (PC), polymethyl methacrylate, polyvinyl chloride, polyacetate resin, casting resins, acrylate, fluorinated ethylene-propylene, polyvinyl fluoride, ethylene tetrafluoroethylene, polyvinyl butyral (PVB), ethylene vinyl acetate, polyurethane (PU), and/or mixtures thereof and/or copolymers thereof.

In the case of a single pane as a vehicle pane, the carrier film can, if it is itself not adhesive, for example, be bonded to the transparent pane via a thermoplastic intermediate layer such as a PVB film. The carrier film can also be protected from the outside by a further cover film.

In the case of a composite pane, the carrier film can contain or consist of a thermoplastic intermediate layer. The carrier film is then typically laminated inside the composite pane, i.e., between the first and the second pane. The carrier film is then preferably made of polyvinyl butyral (PVB), ethylene vinyl acetate, polyurethane (PU), and/or mixtures and/or copolymers thereof. Alternatively, the carrier film can, if it is not self-adhesive, for example, be bonded to one of the panes by a thermoplastic intermediate layer. If the carrier film is arranged on an outer face of the first or second pane, it can be protected from the outside by a further cover film.

In an advantageous embodiment, the at least one first masking strip is printed on the carrier film. Such first masking strips that can be printed on carrier films and, in particular, polymeric carrier films, are well-known to the person skilled in the art, for example, from WO 2019/038043 A1, WO 2002/018154 A 1, US 2014212639 A1, U.S. Pat. No. 9,623,634 B2, or WO 2018/122770 A1.

The first masking strip preferably contains color pigments or dyes, particularly preferably inorganic or organic color pigments or dyes, in particular selected from the group consisting of carbon black (also referred to as industrial carbon black), iron oxide pigments, and mixed-phase oxide pigments. Mixed-phase oxide pigments include, for example, titanate pigments and spinel pigments. The color pigments or dyes are advantageously applied to the thermoplastic intermediate layer in a water-based or solvent-based composition and preferably dried. The color pigments or dyes can be applied to the thermoplastic intermediate layer by spray methods, screen printing, inkjet methods, or other suitable printing methods. The composition with which the first masking strip is printed contains, in particular, no glass-forming oxides or glass frits or other components that result in a glass-like layer after drying and after lamination.

The first masking strip according to the invention is in particular not glass-like and contains no enamel, or is not enamel.

In an advantageous embodiment of the invention, the first masking strip has a thickness of 5 μm (microns) to 40 μm, preferably of 5 μm to 20 μm. Such thicknesses of opaque layers are easy to produce, have sufficient opacity, and can be laminated into a composite pane without further compensating layers or films.

The first masking strip according to the invention can be printed onto any surface of a thermoplastic intermediate layer or onto any surface of individual films of a film composite, in particular even on multiple surfaces.

If the first masking strip is printed onto multiple surfaces, it is then preferably in offset sections. This has the advantage that the total thickness of the intermediate layer with the first masking strip remains lower and is easier to include in laminates.

In another advantageous embodiment, the at least one first masking strip is embedded in the carrier film.

In a first advantageous embodiment of an embedded first masking strip, the carrier film and in particular a thermoplastic intermediate layer serving as a carrier film comprises at least two individual films. Preferably, the first masking strip is arranged between the first individual film and the second individual film and is thus embedded. In an advantageous further development, the first individual film has a thickness of at most 50 μm; and the second individual film, a thickness of more than 50 μm, with the first masking strip printed on the first individual film. Advantageously, the first masking strip is printed on the surface of the first individual film facing the second individual film. This protects and seals the masking strip in the interior of the carrier film.

In another advantageous embodiment of an embedded first masking strip, the first masking strip is implemented as a carrier film colored in some sections or completely. For this purpose, for example, color pigments or coloring components are already introduced into the carrier film during production of the carrier film.

The at least one first masking strip can, in particular at its edge, transition into dots of different sizes. These are intended to soften and relieve the visually massive impression of a black edge and a hard transition.

In addition to the at least one first masking strip arranged on or in a carrier film, the (vehicle) pane can also have further second masking strips. The second masking strips can be arranged, like the first masking strap, on or in a carrier film.

Alternatively, or in combination, the at least one second masking strip can be a masking print that is preferably applied to the at least one pane by printing, in particular screen printing. The masking print is preferably printed directly on the pane. In this case, the printing ink used is a ceramic ink that is baked onto the surface at elevated temperatures (usually at 450° C. to 700° C., for example, during bending of the glass pane) and forms a glass-like coating (or an enamel). The baked ink is preferably permanently lightfast, solvent resistant and abrasion resistant. Such masking prints are known, for example, from WO 2014/174308 A1.

The second masking strip can in particular transition into dots of different sizes. These so-called “screen-printing dots” are intended to break up the visually solid impression of the black screen-printed edge.

The second masking strip is preferably black and can also be referred to as black print. The material of the second masking strip can also be applied to the pane by other common application methods, such as, brushing, rolling, spraying, and the like, and then preferably baked.

According to a preferred embodiment of the vehicle pane, the second masking strip consists of a single layer. This has the advantage of particularly simple and economical production of the vehicle pane, since only a single layer has to be formed for the masking strip.

The second masking strip can, in principle, be applied to each side of the pane. In the case of a composite pane, it is preferably applied to the inner face (side II) of the first pane or to the inner face (side III) of the second pane, where it is protected against external influences. Particularly preferably, it is applied to the inner face (side II) of the first pane.

The first and, optionally, second masking strip comprise a colored, preferably black, colored material. Preferably, the masking strip is opaque, in particular black, in order to serve as visual protection and UV protection, for example, for an adhesive bead. In the case of panes with an electrically controllable functional layer, the masking strip can, for example, also be used to cover busbars and/or connection elements.

In particular, in the case of a vehicle pane, the masking strips serve to mask an adhesive bead for gluing the vehicle pane into a vehicle body, i.e., prevent the outside view of the usually irregularly applied adhesive bead such that a harmonious overall impression of the windshield is created. On the other hand, the masking strips serve as UV protection for the adhesive material used. Continuing irradiation with UV light damages the adhesive and would, over time, loosen the bond of the pane to the vehicle body.

In the context of the present invention, “transparent” means that the total transmittance of the vehicle pane complies with the legal provisions for windshields and preferably has transmittance of more than 70% for visible light and in particular of more than 75%, for example, more than 95%. Correspondingly, “opaque” means light transmittance of less than 30%, in particular less than 25%, for example, less than 5%, in particular 0%.

The vehicle pane according to the invention further includes at least one light-deflecting device for deflecting light into the vehicle interior and/or at least one image display device (e.g., LED display or projector) for displaying image information. It is essential here for the light-deflecting device or image display device to be arranged in the region of the first masking strip, on the vehicle-interior side of the first masking strip. When looking toward the inner side of the vehicle pane, the light-deflecting device is thus situated in front of the masking strip.

The expression “in the region of the at least first masking strip” means that the at least one light-deflecting device or at least one image display device is arranged covering or overlapping the masking strip, when viewed at a right angle through the vehicle pane or in orthogonal projection. The light-deflecting device or image display device and the at least one first masking strip are preferably arranged on different sides of the vehicle pane. The expression “deflecting of light into the vehicle interior” refers to the installed state of the vehicle pane in the vehicle. The light thus redirected leaves the vehicle pane at its inner face.

The at least one light-deflecting device or image display device is preferably implemented in the form of a film, enabling simple integration and attachment to the at least one pane, in particular a composite pane.

In the installed state in the vehicle, a projector arranged in the vehicle interior is associated with the light-deflecting device as an image generator, for example, in the region of the dashboard or in the roof region, the image of which is (re)directed into the vehicle interior by the light-deflecting device. The light from the projector is directed onto the inner face of the vehicle pane and, there, strikes the light-deflecting device.

According to a preferred embodiment of the vehicle pane according to the invention, the light-deflecting device is a holographic light-deflecting device, including at least one holographic optical element suitable for deflecting light. The holographic light-deflecting device is implemented such that incident light can be deflected into the vehicle interior. The specific design of holographic optical elements suitable for deflecting light, such as holographic mirrors or lenses, is not necessary for the understanding of the invention, is well-known to the person skilled in the art, and has already found its way into the patent literature in many cases (in particular in connection with holographic head-up displays) such that it is unnecessary to discuss it in detail here.

The holographic light-deflecting device is preferably implemented such that an incident light beam from the projector can also be redirected into the vehicle interior at an angle different from the angle of incidence, i.e., the condition applicable to reflection, according to which the angle of incidence and the angle of reflection are equal is not necessarily met. The light deflection in the holographic optical element occurs, in particular, by light diffraction.

According to another preferred embodiment of the vehicle pane according to the invention, the light-deflecting device is a holographic waveguide. Holographic waveguides typically include a coupling-in region with a volume hologram for coupling light into the waveguide and a coupling-out region with a volume hologram for coupling light that was coupled into the waveguide out of the waveguide. Holographic waveguides are also well-known to the person skilled in the art, in particular from the patent literature (cf. WO 2020/157307) such that is unnecessary to discuss them in detail here. What is essential here is that at least the coupling-out region is arranged in the region of the at least one first masking strip such that light coupled into the waveguide in the region of the first masking strip is deflected toward the vehicle interior. Coupling of light into the holographic waveguide can also occur outside the region of the first masking strip.

The alternatively provided image display device of the vehicle pane has an image display whose image can be observed directly by the viewer, in particular, the driver. The image display device is preferably a transparent image display device, in particular a display, such as an LED display, OLED display, EL display, or μLED-Display.

The present invention is based on the finding that a light-deflecting device or an image display device overlapping the at least one, typically opaque, first masking strip enables a good image display with high contrast to the masking strip such that it appears bright and is thus also excellently recognizable. Advantageously, this enables a reduction in the projector size or the size of the image display device in the vehicle pane, as well as reduced energy consumption. This is a major advantage of the invention.

The holographic light-deflecting device is preferably implemented such that an incident light beam from the projector can even be redirected into the vehicle interior at an angle different from the angle of incidence, i.e., the condition applicable to reflection, according to which the angle of incidence and the angle of reflection are equal, is not necessarily met. The same applies to the image display device, whose image display can be seen from different angles by the viewer. The vehicle pane thus advantageously enables greater freedom in the arrangement of the components of the head up display in the vehicle. This is another major advantage of the invention.

In addition, as a result of the use of a light-deflecting device, in particular a holographic light-deflecting device, or an image display device, undesirable secondary images can be advantageously avoided if they are arranged on the outer face of the at least one pane (side IV of a composite pane) facing the vehicle interior.

The head-up display according to the invention can thus be implemented cost-effectively and in a technically simple manner, wherein, in particular, only a relatively small region of the vehicle pane has to be provided with the light-deflecting device or the image display device.

According to a preferred embodiment of the vehicle pane according to the invention in the form of a composite pane, the light-deflecting device or image display device is laminated into two thermoplastic intermediate layers between the two individual panes, as a result of which the at least one light-deflecting device or at least one image display device is well protected against external influences. The laminating of the light-deflecting device or image display device can be done with the lamination of the individual panes of a composite pane. In order to avoid glass breakage, it is advantageous for the thermoplastic films to have a smaller thickness where the light-deflecting device or image display device is provided than where the light-deflecting device or image display device is not provided such that differences in thickness caused by the at least one light-deflecting device or at least one image display device are compensated and the region between the two glass panes has a constant thickness overall.

According to another preferred embodiment of the vehicle pane according to the invention, the light-deflecting device or image display device is attached to the outer face (side IV) of the second pane, enabling particularly simple manufacture. In this case, it is advantageous for the light-deflecting device or image display device to be masked by a cover layer, in particular a polymer layer or a glass layer, to protect it against external influences. The glass layer can, in particular, be attached to the composite pane by a thermoplastic intermediate layer.

According to another preferred embodiment of the vehicle pane according to the invention, in addition to the (opaque) first masking strip on the inner face (side II) of the first pane, at least one further second masking strip is arranged on the inner face (side III) of the second pane and/or on the outer face (side IV) of the second pane. The further second masking strip is particularly preferably arranged only on the inner face (side III) of the second pane or only on the outer face (side IV) of the second pane. The further second masking strip serves to improve the adhesion of the panes and is preferably mixed with ceramic particles that give the second masking strip a rough and adhesive surface, which on side IV, for example, supports the gluing of the vehicle pane into the vehicle body. On side Ill, this supports the lamination of the two individual panes of the composite pane.

In a section in which the light-deflecting device or image display device is arranged to overlap the opaque first masking strip on side II, the first masking strip is preferably provided with a widening, in other words, has a greater width (dimension perpendicular to the direction of extension) than in other sections. In this way, the first masking strip can be suitably adapted to the dimensions of the light-deflecting device or image display device.

The at least one pane preferably contains or is made of glass, particularly preferably flat glass, float glass, quartz glass, borosilicate glass, soda lime glass, aluminosilicate glass, or clear plastics, preferably rigid clear plastics, in particular polyethylene, polypropylene, polycarbonate, polymethyl methacrylate, polystyrene, polyamide, polyesters, polyvinyl chloride, and/or mixtures thereof. Suitable glasses are known, for example, from EP 0 847 965 Si.

The at least one pane can be clear, or also tinted or colored, Windshields must have, in the central field of vision, sufficient light transmittance, preferably at least 70% in the primary through-vision region A in accordance with ECE-R43. The at least one pane is preferably bent; in other words, it has a curvature.

The at least one pane can have further suitable coatings known per se, for example, antireflection coatings, nonstick coatings, scratch-resistant coatings, photocatalytic coatings, or sun shading coatings or low-E coatings.

The thickness of the at least one pane, in particular of the two individual panes of the composite pane, can vary widely and be adapted to the requirements of the individual case. Preferably, panes with the standard thicknesses from 1.0 mm to 25 mm and preferably from 1.4 mm to 2.1 mm are used. The size of the panes can vary widely and depends on the use.

The vehicle pane can have any three-dimensional shape desired. Preferably, the at least one pane has no shadow zones such that it can, for example, be coated by cathodic sputtering. Preferably, the at least one pane is flat or slightly or strongly curved in one or a plurality of spatial directions. The at least one pane can be colorless or colored.

The at least one thermoplastic intermediate layer contains is made of at least one thermoplastic, preferably polyvinyl butyral (PVB), ethylene vinyl acetate (EVA), and/or polyurethane (PU) or copolymers or derivatives thereof, optionally in combination with polyethylene terephthalate (PET). The thermoplastic intermediate layer can, however, also contain, for example, polypropylene (PP), polyacrylate, polyethylene (PE), polycarbonate (PC), polymethyl methacrylate, polyvinyl chloride, polyacetate resin, casting resin, acrylate, fluorinated ethylene-propylene, polyvinyl fluoride, and/or ethylene tetrafluoroethylene, or a copolymer or mixture thereof.

The thermoplastic intermediate layer preferably contains or is made of polyvinyl butyral (PVB), particularly preferably of polyvinyl butyral (PVB) and additives known to the person skilled in the art, such as plasticizers. Preferably, the thermoplastic intermediate layer contains at least one plasticizer.

Plasticizers are chemical compounds that make plastics softer, more flexible, smoother, and/or more elastic. They shift the thermoplastic range of plastics to lower temperatures such that the plastics have the desired more elastic properties in the range of the temperature of use, Preferred plasticizers are carboxylic acid esters, in particular low-volatility carboxylic acid esters, fats, oils, soft resins, and camphor, Other plasticizers are preferably aliphatic diesters of tri- or tetraethylene glycol. Particularly preferably used as plasticizers are 3G7, 3G8, or 4G7, where the first digit indicates the number of ethylene glycol units and the last digit indicates the number of carbon atoms in the carboxylic acid portion of the compound. Thus, 3G8 represents triethylene glycol-bis-(2-ethyl hexanoate), in other words, a compound of the formula C₄H₉CH (CH₂CH₃) CO (OCH₂CH₂)₃O₂CCH (CH₂CH₃) C₄H₉.

Preferably, the thermoplastic intermediate layer contains at least 3 wt.-%, preferably at least 5 wt.-%, particularly preferably at least 20 wt.-%, even more preferably at least 30 wt.-%, and in particular at least 40 wt.-% of a plasticizer. The plasticizer preferably contains or is made of triethylene glycol-bis-(2-ethyl hexanoate).

More preferably, the thermoplastic intermediate layer contains at least 60 wt.-%, particularly preferably at least 70 wt.-%, in particular at least 90 wt.-% and, for example, at least 97 wt.-% polyvinyl butyral.

The thermoplastic intermediate layer can be formed by a single film or, also, by more than one film, for example, from three films with different physical properties such as different hardness or plasticity.

The thermoplastic intermediate layer can be formed by one or more thermoplastic films arranged one above another, with the thickness of the thermoplastic intermediate layer preferably being from 0.25 mm to 1 mm, typically 0.38 mm or 0.76 mm.

The thermoplastic intermediate layer can also be a functional thermoplastic intermediate layer, in particular an intermediate layer with acoustically damping properties, an infrared-radiation-reflecting intermediate layer, an infrared-radiation-absorbing intermediate layer, and/or a UV-radiation-absorbing intermediate layer. For example, the thermoplastic intermediate layer can also be a band filter film that blocks out narrow bands of visible light.

The invention further extends to a head-up display with a vehicle pane according to the invention. In a head-up display having at least one light-deflecting device, in particular a holographic light-deflecting device, the head-up display includes an image generator in the form of a projector that is associated with the light-deflecting device. Light (image information) generated by the projector is directed onto the light-deflecting device and is redirected by it into the vehicle interior such that a projection assembly is formed. If multiple light-deflecting devices are provided, a corresponding number of projectors can be provided, associated in each case with the light-deflecting devices. If an image display device (e.g., LED display) is provided instead of a light-deflecting device, no projector is required. Although image generation by means of image display devices such as displays allows smaller virtual image widths, they require significantly less installation space than projectors.

The invention further extends to a vehicle with a head-up display according to the invention.

The invention further extends to a method for producing a vehicle pane according to the invention. The method comprises:
(a) applying at least one carrier film with at least one first masking strip in an edge region of the at least one pane,
(b) arranging at least one light-deflecting device for deflecting light into the vehicle interior or at least one image display device for displaying image information in the region of the first masking strip, on the vehicle-interior side of the first masking strip.

The light-deflecting device for deflecting light into the vehicle interior or image display device is preferably laminated between two thermoplastic films or attached to the outer side of the second pane (inner pane).

To produce a composite pane, at least two panes are preferably joined to one another (laminated) by at least one thermoplastic adhesive layer preferably under the action of heat, vacuum, and/or pressure. Methods known per se can be used to produce a composite pane. For example, so-called autoclave methods can be carried out at an elevated pressure of approx. 10 bar to 15 bar and temperatures from 130° C. to 145° C. for roughly 2 hours, Vacuum bag or vacuum ring methods known per se operate, for example, at roughly 200 mbar and 130° C. to 145° C. The two panes and the thermoplastic intermediate layer can also be pressed in a calendar between at least one pair of rollers to form a composite pane. Facilities of this type for producing composite panes are known and normally have at least one heating tunnel upstream from a press. The temperature during the pressing operation is, for example, from 40° C. to 150° C. Combinations of calendaring and autoclave methods have proved particularly useful in practice. Alternatively, vacuum laminators can be used. These consist of one or more heatable and evacuable chambers in which the first pane and the second pane can be laminated within, for example, about 60 minutes at reduced pressures from 0.01 mbar to 800 mbar and temperatures from 80° C. to 170° C.

The invention further extends to the use of the vehicle pane according to the invention in vehicles for travel on land, in the air, or on water, in particular in motor vehicles. Preferred according to the invention is the use of the vehicle pane in motor vehicles, in particular as a vehicle windshield.

The composite pane can advantageously be the windshield or the roof panel of a vehicle or other vehicle glazing, for example, a partition in a vehicle, preferably in a rail vehicle or a bus. Alternatively, the composite pane can be an architectural glazing, for example, in an exterior façade of a building or a partition in the interior of a building.

The various embodiments of the invention can be implemented individually or in any combinations. In particular, the features mentioned above and to be explained below can be used not only in the combinations indicated but also in other combinations or in isolation without departing from the scope of the present invention.

The invention is explained in greater detail in the following using exemplary embodiments with reference to the accompanying figures. They depict, in simplified representation, not to scale:

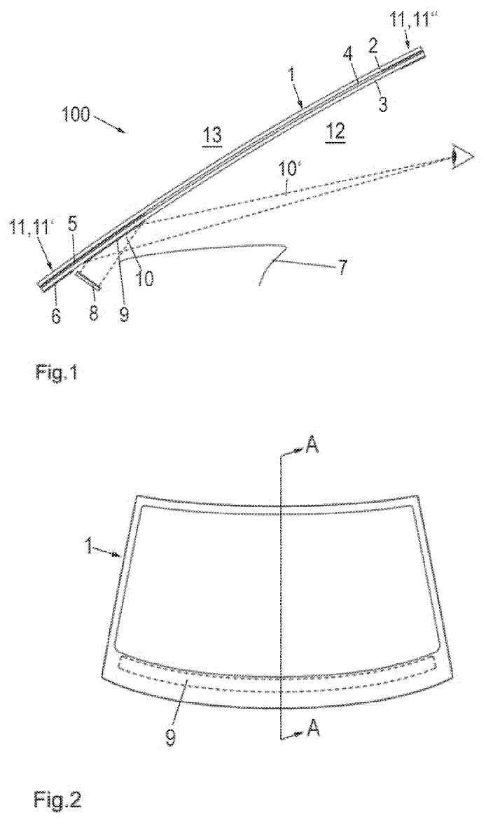

FIG. 1 a cross-sectional view of an exemplary embodiment of the head-up display according to the invention,

FIG. 2 a plan view of the vehicle pane of FIG. 1,

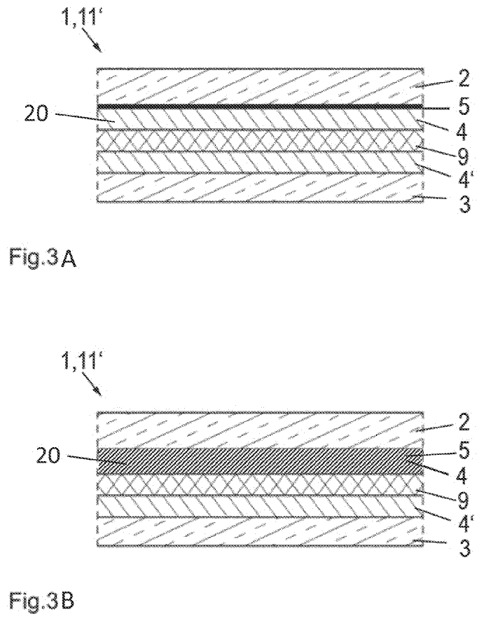

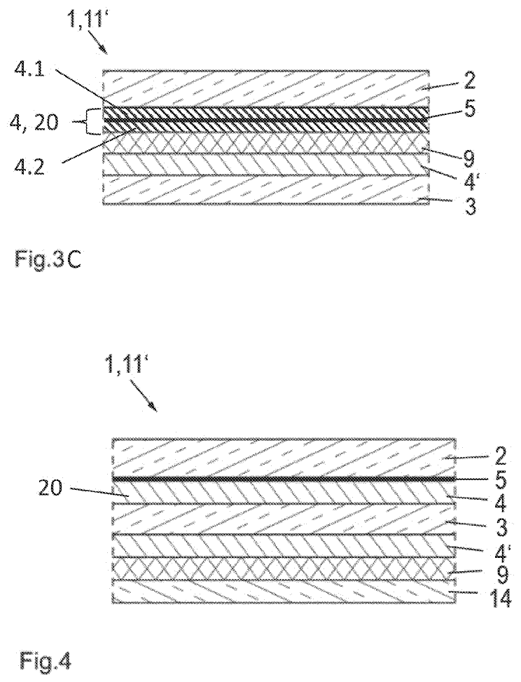

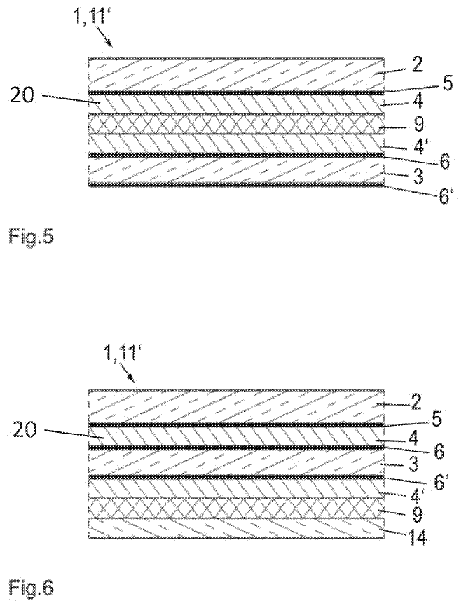

FIG. 3A, 3B, 3C, FIG. 4, FIG. 5, FIG. 6 cross-sectional views of various embodiments of vehicle panes according to the invention,

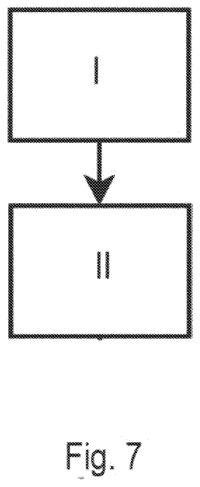

FIG. 7 a flow chart illustrating the method according to the invention.

First, considering FIGS. 1 and 2. FIG. 1 depicts a cross-sectional view of an exemplary embodiment of the head-up display 100 according to the invention in a vehicle in a highly simplified, schematic representation. A plan view of the vehicle pane 1 of the head up display 100 is depicted in FIG. 2. The cross-sectional view of FIG. 1 corresponds to the section line A-A of the vehicle pane 1, as indicated in FIG. 2.

The vehicle pane 1 is implemented in the form of a composite pane (see also FIGS. 3 to 6) and comprises a first pane 2 (e.g., outer pane) and a second pane 3 (e.g., inner pane), which are fixedly joined to one another by a thermoplastic intermediate layer 4. The vehicle pane 1 is installed in a vehicle and separates a vehicle interior 12 from external surroundings 13. For example, the vehicle pane 1 is the windshield of a motor vehicle. Alternatively, the vehicle pane has only one individual pane, preferably in the form of a thermally toughened single pane safety glass (not shown).

The first pane 2 and the second pane 3 are made in each case of glass, preferably thermally toughened soda lime glass and are transparent to visible light. The thermoplastic intermediate layer 4 consists of a thermoplastic, preferably polyvinyl butyral (PVB), ethylene vinylacetate (EVA), and/or polyurethane (PU), optionally, in combination with polyethylene terephthalate (PET).

The outer face I of the first pane 2 faces the external surroundings 13 and is, at the same time, the outer face of the vehicle pane 1. The inner face H of the first pane 2 and the outer face III of the second pane 3 face the intermediate layer 4 in each case. The inner face IV of the second pane 3 faces the vehicle interior 12 and is, at the same time, the inner face of the vehicle pane 1. It goes without saying that the vehicle pane 1 can have any suitable geometric shape and/or curvature. As a vehicle pane 1, it typically has convex curvature.

In the edge region 11 of the vehicle pane 1, there is a frame-like circumferential first masking strip 5 adjacent the inner face (side II) of the first pane 2. The first masking strip 5 is opaque and prevents the view of structures arranged to the inside of the vehicle pane 1, for example, an adhesive bead for gluing the vehicle pane 1 into a vehicle body. The first masking strip 5 is preferably black. The first masking strip 5 is made, for example, of an opaque layer that is printed on a carrier film 20. In this example, the thermoplastic intermediate layer 4 serves as the carrier film 20.

Furthermore, the vehicle pane 1 has, in the edge region 11 on the outer face IV of the second pane 3, a second masking strip 6 made of an electrically nonconductive material. The second masking strip 6 is implemented circumferentially in a frame-like manner. The second masking strip 6 is made, for example, from an electrically nonconductive material conventionally used for masking strips, for example, a black colored screen printing ink that is baked directly on the second pane 3.

On the outer face IV of the second pane 3, there is a holographic light-deflecting device 9, implemented here, for example, as a holographic mirror. When viewed at a right angle through the vehicle pane 1, the light-deflecting device 9 is arranged overlapping the first masking strip 5, with the first masking strip 5 completely overlapping the light-deflecting device 9. Here, the light-deflecting device 9 is, for example, arranged only in the lower (engine-side) section 11′ of the edge region 11 of the vehicle pane 1. However, it would also be possible to arrange the light-deflecting device 9 in the upper (roof-side) section 11″ or in a lateral section of the edge region 11. Furthermore, a plurality of light-deflecting devices 9 can be provided, arranged, for example, in the lower (engine-side) section 11′ and in the upper (roof-side) section 11″ of the edge region 11. For example, the light-deflecting devices could be arranged such that a (partially) circumferential image is generated.

The first masking strip 5 is widened in the lower (engine-side) section 11′ of the edge region 11, i.e., the first masking strip 5 has in the lower (engine-side) section 11′ of the edge region 11 a greater width than in the upper (roof-side) section 11″ of the edge region 11 (as also in the lateral sections of the edge region 11, not visible in FIG. 1) of vehicle pane 1. “Width” means the dimension of the first masking strip 5 perpendicular to its extension. Here, the light-deflecting device 9 is arranged, for example, above the second masking strip 6 (in other words, not overlapping).

The head-up display 100 further has a projector 8 arranged here, for example, in the dashboard 7 as an image generator, corresponding to the exemplary positioning of the light-deflecting device 9 in the lower section 11′ of the edge region 11. The projector 8 is used to generate light 10 (image information) that is directed to the light-deflecting device 9 and is guided by the light-deflecting device 9 as redirected light 10′ into the vehicle interior 12, where it can be seen by a viewer, e.g., driver. It would also, for example, be possible to arrange the projector 8 in the A pillar of a motor vehicle or on the roof (on the vehicle-interior side, in each case), if the light-deflecting device 9 is suitably positioned for this. When multiple light-deflecting devices 9 are provided, a separate projector 8 can be associated with each light-deflecting device 9, i.e., multiple protectors 8 can be arranged. It would also be possible, for example, for the vehicle pane 1 to be a roof panel, side pane, or rear pane.

In the plan view of FIG. 2, the light-deflecting device 9 is shown extending along the lower section 11′ of the edge region 11.

Reference is now made to FIGS. 3A, 3B, 30, 4, 5, and 6, wherein cross-sectional views of various embodiments of the vehicle pane 1 are depicted. The cross-sectional views of FIG. 3A-0 to 6 correspond to the section line A-A in the lower section 11′ of the edge region 11 of the vehicle pane 1, as indicated in FIG. 2.

In the variants of the vehicle pane 1 depicted in FIG. 3A-C, the first (opaque) masking strip 5 is situated directly adjacent the inner face (side H) of the first pane 2. The light-deflecting device 9 is implemented as a film and laminated into the composite pane between two thermoplastic intermediate layers 4, 4′ (e.g., PVB films). In order to compensate for height differences (thickness jump) caused by the light-deflecting device 9 (e.g., holographic film) relative to the rest of the vehicle pane 1, it is advantageous for the thermoplastic intermediate layers 4, 4′ to have a correspondingly smaller thickness than outside the region, where the light-deflecting device 9 is not provided. Thus, a uniform distance (i.e., constant total thickness) between the two panes 2, 3 can be achieved such that any glass breakage during lamination is reliably and safely avoided. When, for example, PVB films are used, they have a smaller thickness in the region of the light-deflecting device 9 than where no light-deflecting device 9 is provided.

Although the light-deflecting device 9 in FIG. 3A-C is depicted schematically and greatly simplified as a single layer, it is understood that the light-deflecting device 9 generally consists of a combination of different materials that are typically used for holographic applications, for example, photopolymers, dichromated gelatins, or silver halides which can be enclosed on one or both sides by polymer films (e.g., PA, PET, TAC, PMMA, PC, . . . ). The inner and outer film do not necessarily have to be made of the same polymer. The exact structure of the light-deflecting device 9 is is not necessary for the understanding of the invention such that it need not be discussed in detail here.

FIG. 3A-C differ only in the design of the first masking strip 5.

In FIG. 3A, the masking strip 5 is an opaque layer that was printed directly onto a carrier film 20, Here, the carrier film 20 is a thermoplastic intermediate layer 4, made, for example, of PVB.

In FIG. 3B, the masking strip 5 consists of an opaque coloring that is embedded in the volume of the carrier film 20. Here, the carrier film 20 is also a thermoplastic intermediate layer 4, made, for example, of colored PVB.

In FIG. 3C, the masking strip 5 consists of an opaque layer that is also embedded in the carrier film 20. Here, the carrier film 20 consists of two individual films 4.1, 4.2 made of a thermoplastic material such as PVB. By lamination, the two individual films 4.1, 4.2 are fixedly bonded to one another and enclose the first masking strip inside. The composite of the individual films 4.1, 4.2 and the opaque layer form a thermoplastic intermediate layer 4, corresponding here to the carrier film 20.

In the variant of the vehicle pane 1 depicted in FIG. 4, the first (opaque) masking strip 5 is situated immediately adjacent the inner face (side II) of the first pane 2, as is also shown and described in the exemplary embodiment of FIG. 3A. Here, the masking strip 5 consists of an opaque layer printed on a thermoplastic film 4 serving as a carrier film 20. The first pane 2 is fixedly joined to the second pane 3 via the thermoplastic film 4. The light-deflecting device 9 is implemented as a film and attached to the outer face (side IV) of the second pane 3 by means of another thermoplastic intermediate layer 4′. A cover layer 14, for example, a polymer layer or a thin glass layer, is applied on the light-deflecting device 9. It goes without saying that here and in the following exemplary embodiments, the first masking strip 5 can also be produced as coloring of the thermoplastic intermediate layer 4 serving as a carrier film 20 (cf. the carrier film 20 of FIG. 3B) or as an inner layer between two individual films (cf. the carrier film 20 of FIG. 3C).

In another exemplary embodiment (not shown) according to FIG. 4, the first masking strip 5 is, for example, arranged on or in the thermoplastic intermediate layer 4′ as carrier film 20. The thermoplastic intermediate layer 4′ is arranged, for example, immediately adjacent the second pane 3. Here, it is important only that the light-deflecting device or the image display device is arranged on the vehicle-interior side relative to the masking strips 5. In addition, a second masking strip can be arranged on the inner side II of the first pane 2, for example, as a baked masking print on the pane 2.

The variant of the vehicle pane 1 depicted in FIG. 5 differs from the variant of FIG. 3A only in that, in addition to the (opaque) first masking strip 5, two further second masking strips 6, 6′ are arranged on the inner face (side III) and on the outer face (side IV) of the second pane 3, for example, as a masking print printed and baked directly onto the pane. The two second masking strips 6, 6′ are used to improve adhesion during production and installation of the vehicle pane 1. Here, when viewed through the vehicle pane 1, the two second masking strips 6, 6′ are narrower than the first masking strip 5 such that the light-deflecting device 9 can be irradiated with light 10 from the projector 8 and the light 10′ redirected into the vehicle interior 12 can be seen by the viewer.

Although two further masking strips 6, 6′ are shown in FIG. 5, it is strongly preferred that only one of the two second masking strips 6, 6′ be provided, i.e., either the masking strip 6 or the masking strip 6′.

The further second masking strip 6, 6′ can be, as a masking print, printed and baked directly on the second pane 3, or, like the first masking strip 5, can be arranged on or in a carrier film 20, which is bonded to the second pane 3. Combinations are also possible: For example, the second masking strip 6 can be arranged on the thermoplastic intermediate layer 4′ as a carrier film 20 and the second masking strip 6′ can be printed and baked directly onto the outer face (side IV) of the second pane 3 as a masking print.

The variant of the vehicle pane 1 depicted in FIG. 6 likewise differs from the variant of FIG. 4 only in that, in addition to the (opaque) first masking strip 5, two further masking strips 6, 6′ are arranged on the inner face (side III) and on the outer face (side IV) of the second pane 3. Since the light-deflecting device 9 is arranged on the outer face (side IV) of the second pane 3, the two further masking strips 6, 6′ can also be opaque. As already stated with regard to FIG. 5, it is strongly preferred that only one of the two second masking strips 6, 6′ be provided, i.e., either the masking strip 6 or the masking strip 6′.

As an alternative to the figure shown here, the first masking strip 5 can also be arranged with the thermoplastic intermediate layer 4′ as a carrier film immediately adjacent the light-deflecting device 9.

The light-deflecting device 9 can also be implemented as a holographic waveguide, wherein the coupling-out of light 10′ occurring overlapping the first masking strip 5. The coupling-in of light 10 can also occur in a region of the pane that does not overlap the first masking strip 5. The above statements apply analogously.

In an alternative embodiment, an image display device (display), e.g., an LED display is provided instead of the light-deflecting device 9 depicted in FIGS. 1 to 6. The viewer can see an image displayed by the image display device directly. In this case, a projector 8 is obviously not required, since the image display device itself serves as an image generator.

In all exemplary embodiments, the light-deflecting device 9 (or the image display device) is arranged on the vehicle-interior side of the first masking strip 5. Viewed from the vehicle interior out or in (direct) view of the inner side of the vehicle pane, the light-deflecting device 9 is arranged in front of the first masking strip 5.

FIG. 7 illustrates the method according to the invention by means of a flow chart. In a first step I, at least one carrier film 20 having at least one (opaque) first masking strip 5 is applied in the edge region 11 of the at least one pane 2, 3. In a second step, at least one light-deflecting device 9 for deflecting light into the vehicle interior or at least one image display device for displaying image information is arranged in the region of the first masking strip 5, on the vehicle-interior side of the first masking strip 5.

It follows from the above statements that the invention makes available an improved vehicle pane or a head-up display equipped therewith that enables good image display with high contrast to the opaque masking strip. Redirection of light into the vehicle interior is possible regardless of the angle of incidence of the light. Undesirable secondary images can be avoided with certain embodiments. The head-up display according to the invention can be produced simply and economically using known production methods.

### REFERENCE CHARACTERS

1 vehicle pane
2 first pane
3 second pane
4, 4′, 4″ intermediate layer
4.1, 4.2 individual film
5 first masking strip
6, 6′ second masking strip
7 dashboard
8 projector
9 light-deflecting device
10, 10′ light
11, 11′, 11″ edge region
12 vehicle interior
13 external surroundings
14 cover layer
20 carrier film
100 head-up display
I outer side of the first pane 2
II inner side of the first pane 2
III inner side of the second pane 3
IV outer side of the second pane 3
A-A′ section line

1. A vehicle pane for a head-up display having, in the installed state, an outer side facing external surroundings and an inner side facing a vehicle interior, the vehicle pane comprising:
at least one transparent pane,
at least one first masking strip in an edge region of the at least one transparent pane, wherein the at least one first masking strip is arranged on or in a carrier film, and the carrier film is bonded to the at least one transparent pane, and
at least one light-deflecting device for deflecting light into the vehicle interior or at least one image display device for displaying image information, which is arranged in a region of the at least one first masking strip, on a vehicle-interior side of the at least one first masking strip.

2. The vehicle pane according to claim 1, wherein the at least one light-deflecting device is a holographic light-deflecting device having at least one holographic optical element suitable for deflecting light, which is designed such that incident light is deflected toward the vehicle interior.

3. The vehicle pane according to claim 1, wherein the at least one light-deflecting device includes a holographic waveguide, which is designed such that light coupled into the waveguide in the region of the first masking strip is deflected toward the vehicle interior.

4. The vehicle pane according to claim 1, wherein the vehicle pane is a composite pane that comprises a first pane having, in the installed state, an outer side facing the external surroundings and an inner side and a second pane having, in the installed state, an inner side facing the vehicle interior and an outer side, which first and second panes are fixedly joined to one another by at least one thermoplastic intermediate layer.

5. The vehicle pane according to claim 4, wherein the carrier film contains or consists of the at least one thermoplastic intermediate layer.

6. The vehicle pane according to claim 4, wherein the at least one light-deflecting device or the at least one image display device is laminated into two thermoplastic intermediate layers.

7. The vehicle pane according to claim 4, wherein the at least one light-deflecting device or the at least one image display device is attached to the outer side of the second pane.

8. The vehicle pane according to claim 7, wherein the at least one light-deflecting device or the at least one image display device is covered by a cover layer.

9. The vehicle pane according to claim 1, wherein the at least one first masking strip is formed in a circumferential frame shape.

10. The vehicle pane according to claim 4, wherein at least one further second masking strip is arranged on the inner side of the first pane, on the inner side of the second pane, and/or on the outer side of the second pane.

11. A head-up display, with a vehicle pane according to claim 1.

12. The head-up display according to claim 11, with a light-deflecting device and an image generator associated with the light-deflecting device.

13. A vehicle with a head-up display according to claim 11.

14. A method for producing a vehicle pane according to claim 1, comprising:
(a) applying a carrier film with at least one first masking strip in an edge region of the at least one pane, and
(b) arranging at least one light-deflecting device for deflecting light into the vehicle interior or at least one image display device for displaying image information in a region of the at least one first masking strip, on a vehicle-interior side of the at least one first masking strip.

15. A method comprising providing a vehicle pane according to claim 1 in a vehicle for travel on land, in the air, or on water.

16. The vehicle pane according to claim 1, wherein the at least one first masking strip is printed on the carrier film or is embedded in the carrier film.

17. The vehicle pane according to claim 8, wherein the cover layer is a polymer layer or a glass layer.

18. The vehicle pane according to claim 9, wherein the at least one first masking strip has in a section that overlaps the at least one light-guiding device or the at least one image display device, a greater width than in sections different therefrom.

19. The vehicle pane according to claim 10, wherein the at least one further second masking strip is a baked masking print.

20. The method according to claim 15, wherein the vehicle pane is a vehicle windshield.
